(19) United States
(12) Patent Application Publication
(10) Pub. No.: US 2023/0349414 A1
(43) Pub. Date: Nov. 2, 2023

(54) ANTI-LOOSENING FASTENER

(71) Applicants: John Chan, Fremont, CA (US); Rong Chen, Fremont, CA (US)

(72) Inventors: John Chan, Fremont, CA (US); Rong Chen, Fremont, CA (US)

(21) Appl. No.: 18/220,663

(22) Filed: Jul. 11, 2023

Related U.S. Application Data
(63) Continuation-in-part of application No. PCT/CN2023/083766, filed on Mar. 24, 2022.

(30) Foreign Application Priority Data
Apr. 11, 2022 (CN) 202220825531.4

(51) Int. Cl. F16B 39/282; F16B 39/24; F16B 35/04

(52) U.S. Cl. CPC F16B 39/282; F16B 39/24; F16B 35/041

(57) ABSTRACT

An anti-loosening fastener includes a bolt including a head and a screw tail, a first washer configured to fit around the screw tail of the bolt, a first nut configured to screw onto the screw tail of the bolt, a second nut configured to screw onto the screw tail of the bolt, a first cutting surface located on the screw tail of the bolt. A first surface of the first washer includes one or more wedge-shaped helical teeth, and a first surface of the first nut includes one or more wedge-shaped helical teeth. The bolt, the first washer, the first nut, the second nut, and the cutting surface are capable of affixing a component. The anti-loosening fastener may also include a second cutting surface located on the screw tail of the bolt.

### CROSS REFERENCE TO RELATED APPLICATION

This application is a continuation-in-part of, and claims priority under 35 U.S.C. § 120 and § 365(c) from International Patent Application No. PCT/CN2023/083766, filed on Mar. 24, 2023, which in turn claims priority from Chinese Application No. 202220825531.4, filed on Apr. 11, 2022 in China. The subject matter of each of the foregoing documents is incorporated herein by reference.

### TECHNICAL FIELD

The present invention relates to the technical field of hardware fasteners, in particular to an anti-loosening fastener, specifically involving bolts, nuts, elastic washers, and fixed washers.

### BACKGROUND INFORMATION

There are many ways to prevent loosening of existing bolts. Common methods include using a bolt to pass through the nut and screw and fix them at one point to prevent the nut and screw from sliding relative to each other as well as using double nuts to prevent loosening. These types of bolt anti-loosening methods are used in specific usage environments, such as fastening train sleepers and rails, locomotives, vehicles, tanks, armored vehicles, ships, excavators, shield machines, loaders, subways, high-speed railways, bridges, mining machinery, petroleum electric machinery, urban assembly integrated construction, military aviation and aerospace, weapons and equipment and other environments that are prone to high-frequency vibration and high temperature are very likely to lead to sliding or deformation of fastening parts, resulting in loosening of fastening parts. Another way to prevent loosening of bolts is to use a welding gun to weld the nuts and screws together or use other foreign objects to fix the bolts and nuts on the object carrying the bolts, in order to achieve the purpose of preventing loosening. This type of bolt anti-loosening method is a one-time anti-loosening structure, which can be damaged once disassembled and cannot be reused, thereby increasing the cost of use and inconvenient maintenance.

### SUMMARY

In a first novel aspect, an anti-loosening fastener includes a bolt including a head and a screw tail, a first washer configured to fit around the screw tail of the bolt, a first nut configured to screw onto the screw tail of the bolt, a second nut configured to screw onto the screw tail of the bolt, a first cutting surface located on the screw tail of the bolt. A first surface of the first washer includes one or more wedge-shaped helical teeth. A first surface of the first nut includes one or more wedge-shaped helical teeth. The bolt, the first washer, the first nut, the second nut, and the cutting surface are capable of affixing a component.

In a second novel aspect, a method, includes: inserting a bolt through a fixed component (the bolt includes a screw tail), inserting the bolt though a first nut, inserting the bolt through a first washer, inserting the bolt through a second washer (a first surface of the second washer including one or more wedge-shaped helical teeth), and inserting the bolt through a second nut (a first surface of the second nut includes one or more wedge-shaped helical teeth). The first surface of the second washer is facing the first surface of the second nut.

In a third novel aspect, an anti-loosening fastener includes a bolt including a screw tail, a first nut, a first washer, and a means for meshing together a first surface of the first nut with a first surface of a first washer. The means includes a first surface of the first nut including one or more wedge-shaped helical teeth, a first surface of the first washer including one or more wedge-shaped helical teeth, and a first cutting surface located on the screw tail of the bolt.

Further details and embodiments and techniques are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a structural schematic diagram of an embodiment of the present invention.

FIG. 2 is a side view diagram of an embodiment of the present invention.

FIG. 3 is a front view diagram of a bolt of an embodiment of the present invention.

FIG. 4 is a front view diagram of a fixed gasket in an embodiment of the present invention.

FIG. 5 is a front view diagram of a nut.

FIG. 6 is the front view diagram of an elastic gasket.

FIG. 7 is a structural schematic diagram of another embodiment of the present invention.

FIG. 8 is a side view diagram of a bolt of another embodiment of the present invention.

FIG. 9 is a front view diagram of a bolt of another embodiment of the present invention.

FIG. 10 is a front view diagram of a fixed gasket in another embodiment of the present invention.

FIG. 11 is a flowchart illustrating a method of the present invention.

FIG. 12 is a flowchart illustrating a method of another embodiment of the present invention.

### DETAILED DESCRIPTION

Reference will now be made in detail to background examples and some embodiments of the invention, examples of which are illustrated in the accompanying drawings. In the description and claims below, relational terms such as “top”, “down”, “upper”, “lower”, “top”, “bottom”, “left” and “right” may be used to describe relative orientations between different parts of a structure being described, and it is to be understood that the overall structure being described can actually be oriented in any way in three-dimensional space.

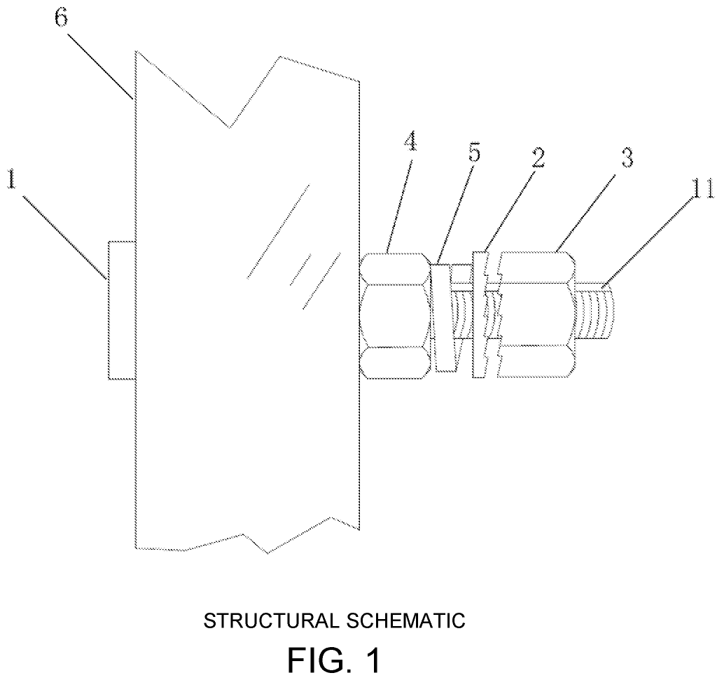

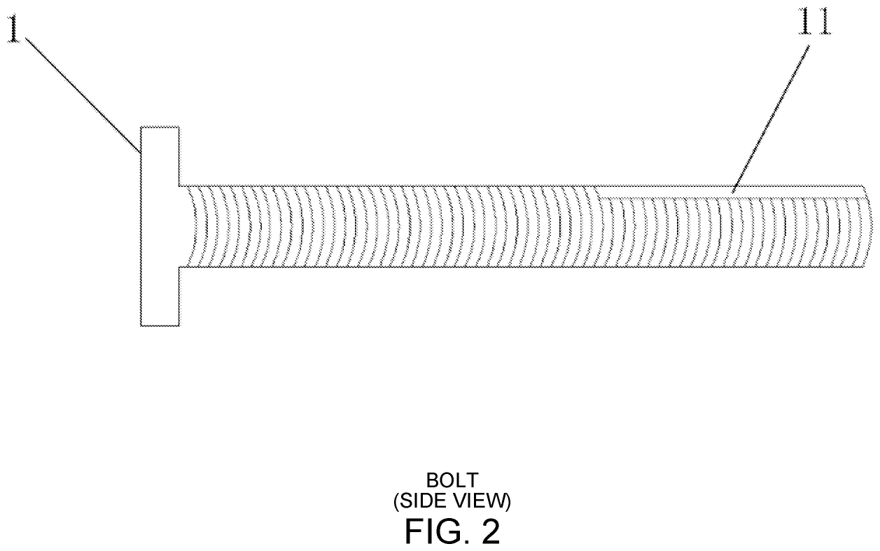

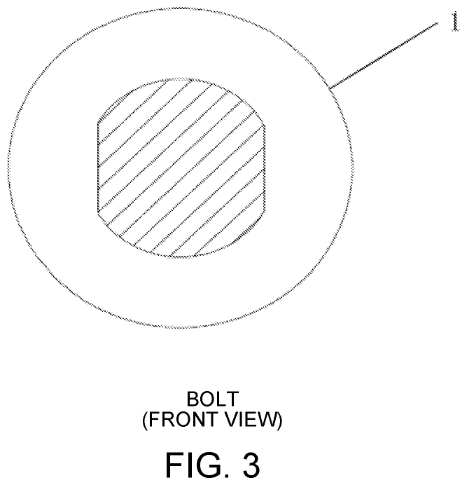

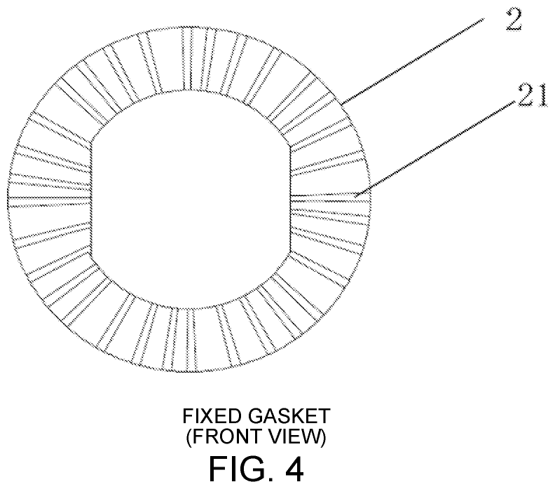

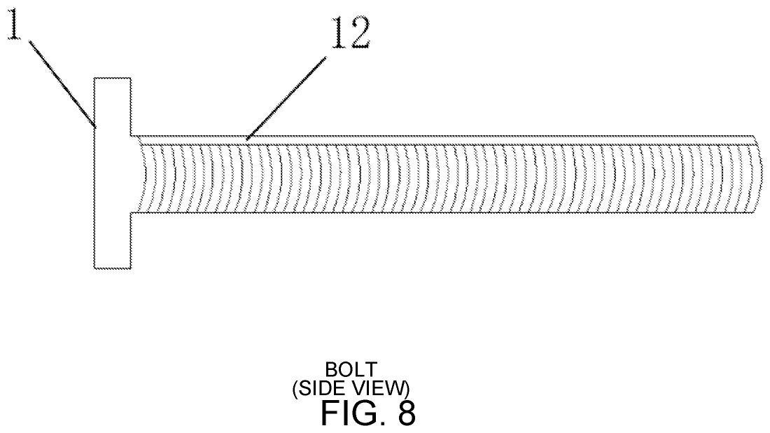

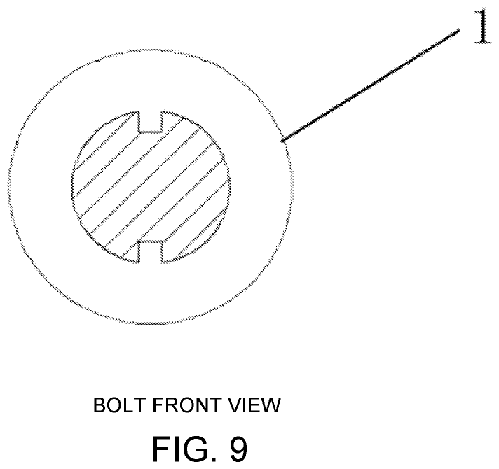

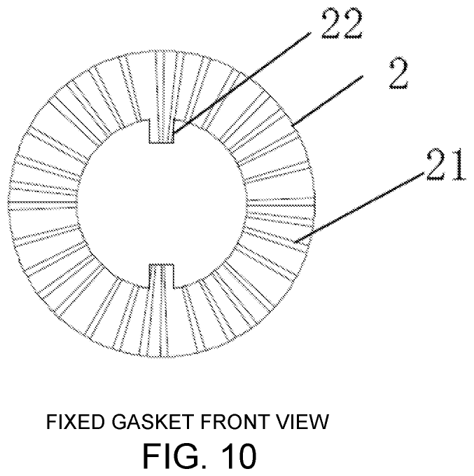

The following items are illustrated in FIGS. 1-10: a bolt 1 1, a fixed gasket 2, a first nut 3, a second nut 4, an elastic gasket 5, a fixed component 6, a washer 7, a cutting surface 11, a vertical groove 12, a wedge shaped groove 21, a buckle 22, and a wedge shaped helical tooth 31.

The present invention proposes an anti-loosening fastener that can ensure that bolts do not loosen under high-frequency vibration and high temperature environments, and its stress remains unchanged compared to standard components.

The technical solution of the present invention is implemented as follows.

A type of anti-loosening fastener, including bolts, fixed components, fixed washers sequentially connected to bolts, and first nut 3.

The fixed component includes second nut 4 and a cutting surface 11, wherein one or two cutting surfaces are cut out on one or both sides of the screw tail of the bolt 1, and the second nut 4 is sleeved on the bolt 1, close to the head of the bolt 1, and set away from the cutting surface 11 of the screw tail of the bolt 1.

The shape and size of the hole in the middle of the fixed gasket 2 match the cross-sectional surface of the screw tail of the bolt 1, so that the fixed gasket 2 is fixed relative to the bolt 1.

The first nut 3 is set away from the head of the bolt 1, and the surface of the first nut 3 in contact with the fixed gasket 2 is equipped with at least two wedge-shaped helical teeth 31. The surface of the fixed gasket 2 in contact with the first nut 3 is equipped with wedge-shaped grooves 21 that mesh with the wedge-shaped helical teeth 31.

Furthermore, the fixed component can be replaced by a vertical groove 12 and a buckle that is matched with the vertical groove 12. The vertical groove 12 is arranged on the screw tail of the bolt 1, parallel to the axis of the screw tail of the bolt 1, and the buckle is arranged on the inner side of the fixed gasket 2.

Furthermore, the wedge-shaped helical teeth 31 are evenly distributed on the surface of the first nut 3, radiating outwards from the center. Furthermore, it also includes an elastic gasket 5, which is sleeved onto the bolt 1 and arranged on the side near the bolt 1 head of the fixed gasket 2. The elastic gasket 5 has elasticity to support close contact between the fixed gasket 2 and the first nut 3.

Furthermore, the elastic gasket 5 is a circular ring gasket, and the circular ring gasket has a notch, and the two surfaces opposite the notch are misaligned.

The Beneficial Effects of the Present Invention:

The present invention utilizes the inherent structure of fasteners to effectively prevent loosening of bolts and nuts under high-frequency or low-frequency vibrations or irregular frequency vibrations, as well as under high-temperature or low-temperature vibrations or high-temperature or low-temperature environments, thereby avoiding major accidents and having reusability. The setting of a second nut 4 ensures that the stress of the fastener is consistent with that of the original standard component. The position of the fixed gasket 2 is limited by the fixed component. Once the wedge-shaped helical teeth 31 on the surface of first nut 3 are screwed into the wedge-shaped groove 21 of the fixed gasket 2, they cannot be unscrewed, thereby achieving the effect of never loosening. The vertical groove 12 set on the screw tail of the bolt 1 has less impact on the original stress of the bolt 1 and it is combined with the buckle of the fixed gasket 2 so to fasten the fixed gasket 2 to the bolt 1. The shape and size of the central hole of the fixed gasket 2 should match the cross-sectional shape and size of the screw tail of bolt 1 so to prevent sliding or displacement between the fixed gasket 2 and the bolt 1. The elastic gasket 5 (circular ring gasket) has a gap and misalignment to ensure elasticity to support a tighter contact between the fixed gasket 2 and the first nut 3.

The following will provide a clear and complete description of the technical solution in the embodiments of the present invention, in conjunction with the accompanying drawings. Obviously, the described embodiments are only a part of the embodiments of the present invention, not all of them. Based on the embodiments in the present invention, all other embodiments obtained by ordinary technicians in the art without creative labor fall within the scope of protection of the present invention.

As shown in FIGS. 1-6, in one embodiment, an anti-loosening fastener comprises a bolt 1, a fixed component 6, a fixed gasket 2 sequentially connected to the bolt 1 and a first nut 3. The fixed components include a second nut 4 and cutting surface 11. One or two cutting surface 11 are cut out on one or both sides of the screw tail of bolt 1. Second nut 4 is sleeved on bolt 1, close to the head of bolt 1, and set away from the cutting surface 11 of the screw tail of bolt 1. The shape and size of the hole in the middle of the fixed gasket 2 match the cross-sectional surface of the screw tai of bolt 1, so that the fixed gasket 2 is fixed relative to the bolt 1. The first nut 3 is set away from the head of bolt 1 and the surface of the first nut 3 is in contact with fixed gasket 2, which is equipped with at least 2 wedge-shaped helical teeth 31. The surface of fixed gasket 2 that is in contact with first nut 3 is equipped with wedge-shaped grooves 21 that mesh with wedge-shaped helical teeth 31. Two wedge-shaped helical teeth 31 can achieve a tightening effect, but the more wedge-shaped helical teeth 31, the more precise the bolt 1 fasteners will be. The deeper the teeth of the wedge-shaped helical teeth 31, the less likely the first nut 3 is to rotate. First nut 3 is in a quadrangle or hexagonal shape, with an internal thread in the center hole that matches the screw tail of bolt 1 and external threads of bolt 1. The setting of the second nut 4 ensures that the stress of the fastener is consistent with the national bolt standard. After the position of the fixed gasket 2 is limited by the fixed component, the wedge-shaped helical teeth 31 on the surface of first nut 3 cannot be unscrewed once they are screwed into the wedge-shaped groove 21 of the fixed gasket 2, thereby achieving the effect of never loosening. The present invention ensures that the bolt 1 does not become loose and has reusability under high-frequency vibration and high temperature environments. The production process can be slightly improved on the basis of the original production process of ordinary bolts, and the production equipment can be used to achieve the manufacturing of the product, which is convenient for promotion and application.

Specifically, the shape and size of the hole in the middle of the fixed gasket 2 match the cross-sectional surface of the screw to prevent sliding or displacement between the fixed gasket 2 and the bolt 1.

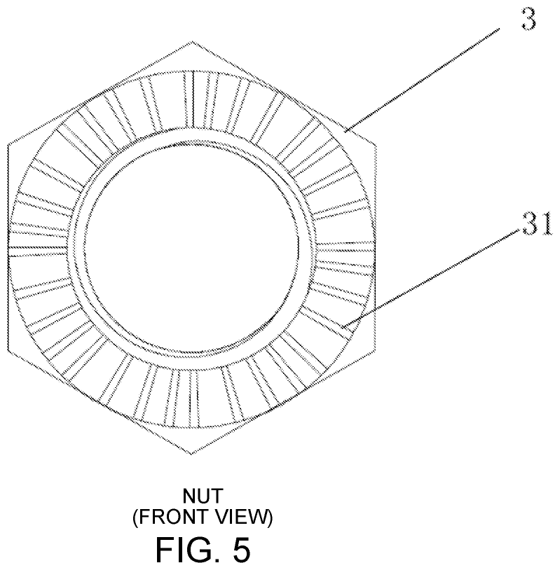

As shown in FIG. 5, preferably, the wedge-shaped helical teeth 31 are evenly distributed on the surface of first nut 3, radiating outwards from the center.

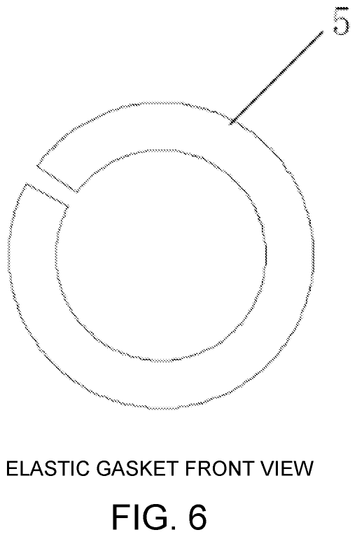

As shown in FIG. 6, it is preferable to also include an elastic gasket 5, which is sleeved onto bolt 1 and arranged on the side of the fixed gasket 2 near the head of bolt 1. The elastic gasket 5 has elasticity to support close contact between the fixed gasket 2 and first nut 3. The elastic gasket 5 has elasticity to support the tight contact between the fixed gasket 2 and the first nut 3.

As shown in FIG. 6, it is preferred that the elastic gasket 5 is a circular ring gasket with a notch, and the two opposite surfaces of the notch are misaligned to ensure that the elastic gasket 5 has elasticity to support the closer contact between the fixed gasket 2 and the first nut 3.

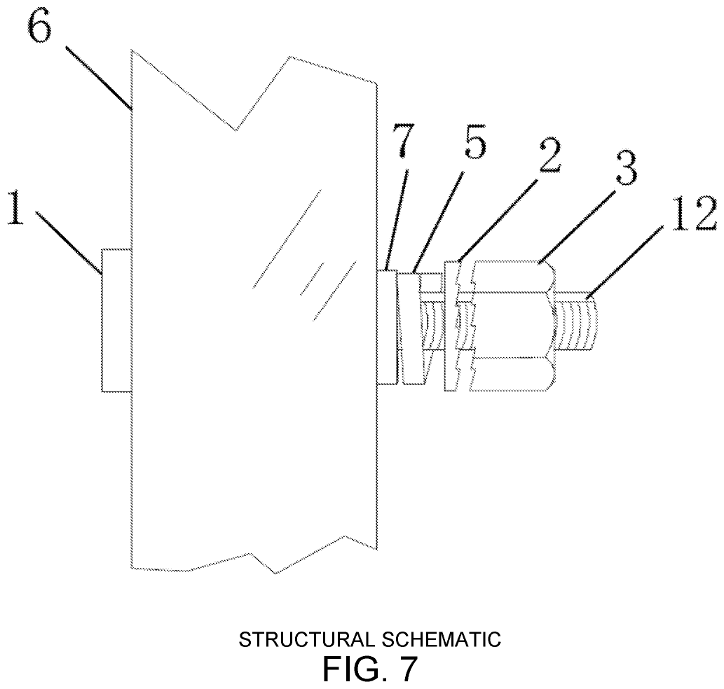

As shown in FIGS. 7-10, in another preferred embodiment, the fixed component can also be replaced by a vertical groove 12 and a buckle 22 matched with the vertical groove 12. The vertical groove 12 is arranged on the screw, parallel to the axis of the screw, and the buckle 22 is arranged on the inner side of the fixed gasket 2. The vertical groove 12 opened on the screw tail of the bolt 1 has less impact on the stress of the original standard component of bolt 1. It is combined with the buckle 22 of the fixed gasket 2 to fasten the fixed gasket 2 to bolt 1. In this embodiment, a washer 7 can also be installed between the fixed component 6 and the elastic gasket 5 (circular ring gasket) to avoid damage to the fixed component 6 caused by the misaligned elastic gasket 5. In the specific installation and use process of an embodiment, first tighten second nut 4. Second nut 4 generates a force to squeeze the fixed component 6 until it is fully tightened. At this point, second nut 4 falls onto the complete external thread of the screw tail of bolt 1. Then, when first nut 3 is tightened, first nut 3 generates a force to squeeze the fixed gasket 2, which in turn drives the fixed gasket 2 to squeeze the elastic gasket 5, and further drives the elastic gasket 5 to squeeze the second nut 4 until it is fully tightened. When bolt 1 or first nut 3 is loosened, the wedge-shaped helical teeth 31 of first nut 3 mesh with the wedge-shaped groove 21 of fixed gasket 2 to generate a reverse force, ensuring that first nut 3 cannot slide or move to cause loosening. The size shape of the center hole in the fixed gasket 2 match the cross-sectional surface of the screw tail of bolt 1, as the section 11 structure (cutting surface) of the screw tail of bolt 1 fixes the rotation of the fixed gasket 2, and an elastic gasket 5 is added between the fixed gasket 2 and the second nut 4 to ensure that the fixed gasket 2 cannot move along the screw tail of bolt 1. This way, the screw tail of bolt 1, elastic gasket 5, fixed gasket 2, and first nut 3 lock the fixed component 6 that needs to be fixed into an unbreakable whole. This ensures that bolt 1 and first nut 3 will not loosen and lead to detachment and/or accidents.

In another embodiment, during the specific installation and use process, when the bolt 1 or first nut 3 is tightened, the first nut 3 generates a force to compress the fixed gasket (fixed washer) 2, which in turn drives the fixed washer 2 to compress the elastic gasket (elastic washer) 5 and washer 7, and further drives the washer 7 to compress the fixed component 6 until it is fully tightened. The size and shape of the center hole in the fixed gasket 2 match the cross-sectional surface of the screw tail of bolt 1. The buckle 22 of the fixed gasket 2 is inserted into the vertical groove 12 of the screw, and the fixed gasket 2 is firmly fixed on the screw without rotation. The structural functions of other components are consistent with the above embodiments.

The above is only a preferred embodiment of the present invention and is not intended to limit it. Any modifications, equivalent substitutions, improvements, etc. made within the spirit and principles of the present invention should be included in the scope of protection of the present invention.

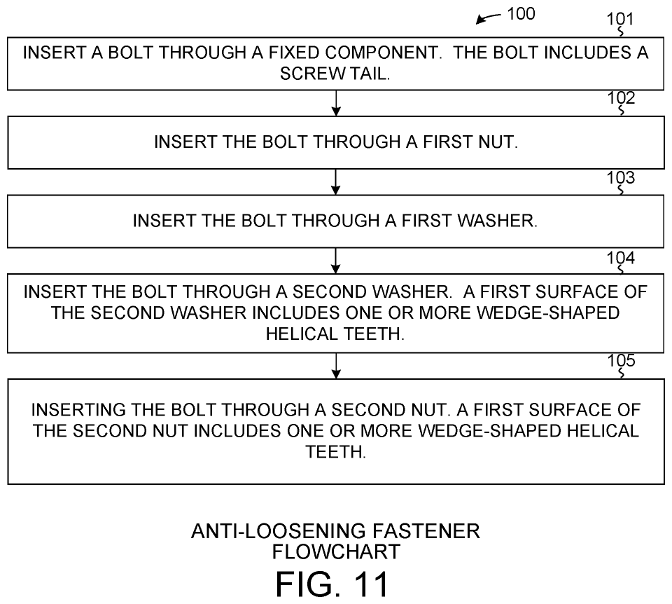

FIG. 11 is a flowchart 100 illustrating a method of the present invention. In step 101, a bolt is inserted through a fixed component. The bold includes a screw tail. In step 102, the bolt is inserted through a first nut. In step 103, the bolt is inserted through a first washer. In step 104, the bolt is inserted through a second washer. A first surface of the second washer includes one or more wedge-shaped helical teeth. In step 105, the bolt is inserted through a second nut. A first surface of the second nut includes one or more wedge-shaped helical teeth.

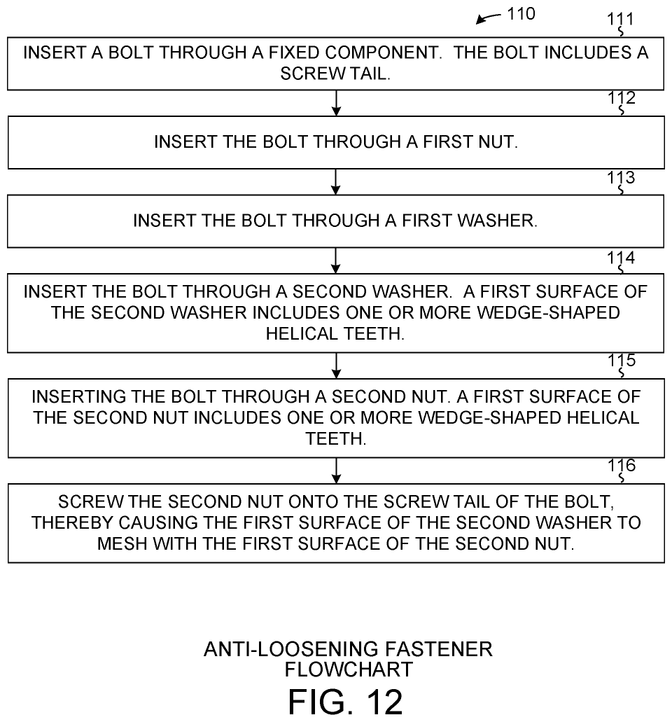

FIG. 12 is a flowchart 110 illustrating a method of another embodiment of the present invention. In step 111, a bolt is inserted through a fixed component. The bold includes a screw tail. In step 112, the bolt is inserted through a first nut. In step 113, the bolt is inserted through a first washer. In step 114, the bolt is inserted through a second washer. A first surface of the second washer includes one or more wedge-shaped helical teeth. In step 115, the bolt is inserted through a second nut. A first surface of the second nut includes one or more wedge-shaped helical teeth. In step 116, the second nut is screwed onto the screw tail of the bolt, thereby causing the first surface of the second washer to mesh with the first surface of the second nut.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

What is claimed is:

1. An anti-loosening fastener, comprising:
a bolt including a head and a screw tail;
a first washer configured to fit around the screw tail of the bolt, wherein a first surface of the first washer includes one or more wedge-shaped helical teeth;
a first nut configured to screw onto the screw tail of the bolt, wherein a first surface of the first nut includes one or more wedge-shaped helical teeth;
a second nut configured to screw onto the screw tail of the bolt;
a first cutting surface located on the screw tail of the bolt, wherein the bolt, the first washer, the first nut, the second nut, and the cutting surface are capable of affixing a component.

2. The anti-loosening fastener of claim 1, further comprising:
a second cutting surface located on the screw tail of the bolt.

3. The anti-loosening fastener of claim 1, wherein the first washer has a hole, and wherein the hole in the first washer has a shape and size, and wherein the shape and size of the hole of the first washer is approximately equal to the shape and size of a cross-sectional area of the screw tail of the bolt.

4. The anti-loosening fastener of claim 1, wherein the first surface of the first nut is configured to contact the first surface of the first washer.

5. The anti-loosening fastener of claim 4, wherein the first surface of the first nut is configured to mesh together with the first surface of the first washer.

6. The anti-loosening fastener of claim 1, further comprising:
a first vertical groove located on the screw tail of the bolt.

7. The anti-loosening fastener of claim 6, wherein the first washer includes a first buckle that is configured so to fit into the first vertical groove when the bolt is inserted into the first washer.

8. The anti-loosening fastener of claim 6, further comprising:
a second vertical groove located on the screw tail of the bolt.

9. The anti-loosening fastener of claim 6, wherein the first washer includes a second buckle that is configured so to fit into the second vertical groove when the bolt is inserted into the first washer.

10. The anti-loosening fastener of claim 1, wherein the wedge-shaped helical teeth of the first nut are uniformly distributed on the surface of the first nut and radiate outwards from a center of the first nut.

11. The anti-loosening fastener of claim 1, further comprising:
a second washer, wherein the second washer is elastic and configured to fit around the screw tail of the bolt.

12. The anti-loosening fastener of claim 11, wherein a first surface of the second washer is configured to contact a second surface of the first washer.

13. The anti-loosening fastener of claim 11, wherein the second washer is a circular ring gasket.

14. The anti-loosening fastener of claim 13, wherein the second washer includes a notch, and wherein a first surface of the notch and a second surface of the notch are misaligned.

15. The anti-loosening fastener of claim 13, wherein a second surface of the second washer is configured to contact a first surface of the second bolt.

16. A method, comprising:
(a) inserting a bolt through a fixed component, wherein the bolt includes a screw tail;
(b) inserting the bolt though a first nut;
(c) inserting the bolt through a first washer;
(d) inserting the bolt through a second washer, wherein a first surface of the second washer including one or more wedge-shaped helical teeth; and
(e) inserting the bolt through a second nut, wherein a first surface of the second nut includes one or more wedge-shaped helical teeth, and wherein the first surface of the second washer is facing the first surface of the second nut.

17. The method of claim 16, further comprising
(f) screwing the second nut onto the screw tail of the bolt, thereby causing the first surface of the second washer to mesh with the first surface of the second bolt.

18. The method of claim 16, wherein a first cutting surface is located on the screw tail of the bolt.

19. An anti-loosening fastener, comprising:
a bolt including a screw tail;
a first nut;
a first washer; and
a means for meshing together a first surface of the first nut with a first surface of a first washer.

20. The anti-loosening fastener of claim 19, wherein the means includes a first surface of the first nut including one or more wedge-shaped helical teeth, a first surface of the first washer including one or more wedge-shaped helical teeth, and a first cutting surface located on the screw tail of the bolt.
